(19) United States
(12) Patent Application Publication
(10) Pub. No.: US 2014/0142992 A1
(43) Pub. Date: May 22, 2014

(54) Trip Planning and Budgeting

(71) Applicants: Frank Anthony Nuzzi, Pflugerville, TX (US); James Brett Sowder, Austin, TX (US)

(72) Inventors: Frank Anthony Nuzzi, Pflugerville, TX (US); James Brett Sowder, Austin, TX (US)

(21) Appl. No.: 13/679,214

(22) Filed: Nov. 16, 2012

(51) Int. Cl. G06Q 10/02

(52) U.S. Cl. CPC G06Q 10/02; G06Q 30/0631
USPC 705/5; 705/26.7

(57) ABSTRACT

Methods and systems can facilitate enhanced planning and spending during travel. According to an embodiment, each travel destination of a trip can have one or more payment events or purchases associated therewith. The purchases can be prepaid, such as prior to the trip. Recommendations for the purchases can be made by the system based, at least in part, upon the user's spending history and/or social network indications.

### BACKGROUND

1. Technical Field

The present disclosure generally relates to electronic commerce and, more particularly, relates to methods and systems for planning and budgeting trips such as vacations and business trips.

2. Related Art

Travel plans, e.g., itineraries, are well known. Such travel plans typically list the transportation used to travel to one or more destinations. For example, when flying the itinerary can list the specific airline and flight selected, as well as the departure airport, departure time, arrival airport, and arrival time. Any time between flights at layovers can also be shown. The cost of the flight or flights can be shown.

The itinerary can also list any hotel accommodations to be provided at the destinations. For example, the itinerary can list the name of the hotel, the address of the hotel, a telephone number for the hotel, an arrival date, and a departure date. The cost of the hotel can be shown.

Such an itinerary can help a traveler with the trip. The itinerary can help assure that the traveler arrives at the airport on time. The itinerary can make it much easier for the traveler to find the correct hotel at the travel destination, such as by providing a cab driver with the address to the hotel. The itinerary can provide a convenient listing of what travel destinations will be visited and the dates on which the travel destinations will be visited.

### BRIEF DESCRIPTION OF THE DRAWINGS

FIG. 1 is a block diagram of a system for trip planning and budgeting, according to an embodiment;

FIG. 2 is a flow chart showing a method for trip planning and budgeting, according to an embodiment;

FIG. 3 is a flow chart showing further detail of the method for trip planning and budgeting, according to an embodiment; and

FIG. 4 is a block diagram of an example of a computer that is suitable for use in the system for trip planning and budgeting, according to an embodiment.

### DETAILED DESCRIPTION

Methods and systems can facilitate enhanced planning and spending during travel. According to an embodiment, each travel destination of a trip can have one or more payment events or recommended purchases associated therewith. For example, the purchases can include a hotel stay, lunch, dinner, a theatrical event, and/or a souvenir. The purchases can be prepaid, such as prior to the trip. Recommendations for the purchases can be made by the system based, at least in part, upon the user's spending history and/or social network indications. The methods and systems can be particularly useful for more complicated trips such as multiple city vacations or business trips. In such instances, at least some of the planning burden can be assumed by the system.

More particularly, each travel destination can have a budget associated therewith. The budget can contemplate the expected or recommended purchases. The budget can also contemplate unexpected or incidental purchases. The cost of the entire trip or any portion thereof can be prepaid. For example, the cost of the entire trip or any portion thereof can be prepaid using a payment provider such as PayPal, Inc. Such prepayment can define a budget for the entire trip or any portion thereof. Such prepayment can define a budget for each or selected travel destinations.

The system can make recommendations for purchases by the user or by others. For example, the system can recommend a hotel, a rental car agency, and/or a restaurant. The recommendations can be reviewed by the user and can be accepted or rejected by the user. The recommendations can be accepted or rejected on an itemized based, e.g., individually. The recommendations can be accepted or rejected as a whole. Such review can take place prior to the trip or during the trip.

Rather than recommendations, the system can make purchases for the user. For example, the system can reserve the hotel, the rental car, and the restaurant. The user can define what the system can recommend and what the system can purchase for the user during a set up process or at any other time. By making such purchases for the user, much of the burden associated with trip planning can be avoided by the user.

Any unspent amount of a prepayment from one travel destination can be spent at the next travel destination, can be spent at any desired travel destination or destinations, can be spread (either equally or unequally) over the remaining travel destinations, or can be used in any other manner. By spending such unspent amounts at the next travel destination or spreading such unspent amounts over the remaining travel destinations the total trip budget can be maintained. The system can make recommendations and/or purchases based upon any such unspent amounts.

The system can receive communications from the user that provide the user's location. For example, a global positioning system (GPS) enabled mobile device of the user can communicate with the system to keep the system substantially updated regarding the user's location. Such location information can be used by the system to make decision regard purchases to be made by the user and/or whether a card of the user is being used legitimately. For example, if the mobile device is in one location and a card of the user is being used in another location, the system can assume that the card has been lost or stolen and can require additional security measures prior to additional use of the card, as discussed herein.

The system can take various different actions when the user deviates from an expected or predetermined path. For example, when the user deviates from the expected trip path by more than the predetermined amount, the user's payment provider account can be locked or put on hold. Such a deviation from the expected trip path can indicate the user's mobile device and possibly other property has been lost or stolen. The hold can effect deactivation of a card of the user, such as a payment provider card, bank card, credit card, or debit card.

The user's payment provider account can remain on hold unit the user verifies that the hold should be removed, such as via a telephone call, text message, email, or personal visit to an office or agent of the payment provider. For example, the user can call the payment provider and provide identification information, as well as security information (such as the mother's maiden name, birthdate, social security number, address, and/or password) to have the hold removed. As a further example, the user can be required to make a personal visit to an office or agent of the payment provider with identification and/or the card in hand.

The user can be required to make further payment to have the hold removed. For example, if purchases with the card have exceeded a predetermined amount or limit, then such a payment can be required. The payment can be required to be made at a specific location, such as the location of a specific merchant. Making the payment at the specific location can be an indication that the suspect card use is legitimate. The merchant can take security measures, such as requiring identification from the user to verify the identity thereof.

Upon departing a travel destination, the system can take desired actions. The actions can be non-payment related. For example, upon departing a travel destination the system can upload the user's vacation photos for the travel destination into the cloud, to a website of the user, to another person, to a computer (such as a desktop computer in the user's home), or to a social networking site. As a further example, the system can automatically confirm a hotel reservation when the user is within a predetermined distance and/or within a predetermined time from arrival with respect to the hotel. As yet a further example, the system can automatically place an order and/or have an item shipped (such as to the next travel destination) when the user is at a predefined location. The user can define such locations. Alternatively, the system can define such locations, such as based upon general parameter provided by the user during a set up process. The user can define the actions to be taken at the locations, such as during a setup process for the trip.

The system can make recommendations for use of any excess funds along the route, such to each travel destination. The recommendation can be based, at least in part, upon the user's purchase history and/or social network indications (such as the user's likes), for example. The user can specify to the system the amount of any such excess funds. That is, the excess funds can be defined by the user. The system can determine the amount of excess funds based upon the budget and the actual expenditures of the user.

The recommendation can be based, at least in part, upon incentives at the travel destinations that are expected to be available when the user is expected to be at the travel destinations. For example, a recommendation can be made for the user to eat at a restaurant located at a travel destination when the restaurant will provide a substantial discount during the time that the user is at the travel destination. Thus, the recommendations can be based, at least in part, upon where the user will be and when the user will be there, as well as upon where the incentives will be and when the incentives will be there.

According to an embodiment, a system can comprise one or more memories storing account information regarding a user. The account information can include user preferences. For example, the account information can include user preferences that define which airlines, rental car agencies, hotels, and restaurants the user prefers. One or more processors can be operable to receive a first communication that includes at least one travel destination and a budget for each travel destination. The one or more processors can be operable to access the user preferences, access merchant information for each of the travel destinations, and determine, at least in part from the user preferences and the merchant information, product recommendations for each travel destination. The one or more processors can be operable to send a communication to a user device including the product recommendations.

The merchant information can be access via the Internet. For example, the merchant information can be accessed via merchant websites, blogs, social networks, or the like. The merchant information can be accessed via a database of the system. The database can be a database of a payment provider, online travel service, or online seller, for example.

At least one of the memories and at least one of the processors can be associated with a payment server, such as a payment server of PayPal, Inc. The payment server can be configured to receive pre-payment for purchases made by the user at the travel destinations. Each travel destination can have a specified portion of the pre-payment associated therewith to define a budget for each travel destination.

The one or more processors can be further operable to receive a prepaid amount from the user for each destination. The one or more processors can be further operable to spend a prepaid amount for the user at each destination. The first communication can include a plurality of travel destinations.

The first communication can include a plurality of travel destinations. When spending of the user is less than the budget for one travel destination by an amount, then the budget for the next destination, any other destination, or any combination of destinations can be increased by the amount. For example, if the budget for one travel destination is $1,000 and only $800 is spent at that travel destination, then the remaining $200 can be can be added to the budget for the next or any other travel destination.

When spending of the user is less than the budget for one destination by an amount, then the budget for the remaining destinations can be increased by the amount and the amount can be split among the remaining travel destinations. For example, if the budget for one travel destination is $1,000 and only $800 is spent at that travel destination, then the remaining $200 can be can be split among the remaining travel destinations.

The system can determine how such money is to be allocated or can suggest an allocation, such as according to a method predefined during the setup process. The system can define or suggest an allocation based upon the user's spending history and/or likes. The user can determine how such money is to be allocated in real time and/or can modify any predefined allocation. Such money can be spent to upgrade a hotel, car rental, or restaurant, for example. The money can be used to take advantage of a recently announce sale or incentive.

The recommendations and/or purchases (by the system or by the user) can be modified substantially in real time. For example, the recommendations and/or purchases (by the system or by the user) can be modified to take advantages of changes in offering, prices, incentives, or environmental conditions.

The product recommendations can be determined, at least in part, from a social network of the user. The system can use likes found on a social network website for the user to determine product recommendation. For example, if the user likes American Airlines, Hilton Hotels, Avis, and Golden Corral, then these merchants can be recommended at the travel destinations.

The one or more processors can be further operable to receive a third communication from a mobile device of the user including a GPS location of the user. The one or more processors can be further operable to receive a third communication including an indication that the user has left one of the travel destinations and the one or more processors can perform a non-payment action for the user in response to the third communication.

For example, the one or more processors can be further operable to receive the third communication including an indication that the user has left one of the travel destinations and in response the one or more processors can upload photographs for the user in response to the third communication. As a further example, the one or more processors can be further operable to confirm a hotel reservation for the user when the user is within a predetermined distance from the hotel.

As a further example, the one or more processors can be further operable to place an order for the user when the user is at a predetermined location. As a further example, the one or more processors can be further operable to ship an item for the user when the user is at a predetermined location. As a further example, the one or more processors can be further operable to ship an item to a next travel destination of the user when the user is at a predetermined location.

The one or more processors can be further operable to receive a third communication including an indication that the user has deviated by more than a predetermined amount from an expected path. In response to the deviation, the one or more processors can perform one or more predetermined operations in response to the third communication, as discussed herein.

According to an embodiment, a method can comprise storing, in one or more memories, account information regarding a user. The account information can include user preferences. The method can further comprise receiving, electronically via one or more processors, a first communication including at least one travel destination and a budget for each travel destination. The user preferences can be accessed, electronically via the one or more processors. Merchant information for each of the travel destinations can be accessed, electronically via the one or more processors. Product recommendations for each travel destination can be determined, electronically via the one or more processors and at least in part from the user preferences and the merchant information. A communication to a user device can be sent electronically via the one or more processors. The communication can include the product recommendations.

According to an embodiment, a computer program product can comprise a non-transitory computer readable medium having computer readable and executable code for instructing one or more processors to perform a method. The method can comprise storing account information regarding a user, the account information including user preferences; receiving a first communication including at least one travel destination and a budget for each travel destination; accessing the user preferences; accessing merchant information for each of the travel destinations; determining, at least in part from the user preferences and the merchant information, product recommendations for each travel destination; and sending a communication to a user device including the product recommendations.

According to an embodiment, when the user can not readily decide among two or more alternatives, such as airlines, rental car agencies, hotels, or restaurants, then the system can help the user to decide. For example, if the user is trying to decide between two hotels, the user can put a question to his social network about which hotel they think is better. The system, e.g., PayPal, Inc., can monitor the results of the social network poll and make a purchase, e.g., a hotel reservation, after a voting threshold has been met or when the user is at a certain GPS location (such as near the travel destination where the two hotels are located).

Also, if not enough people vote, then rather than automatically getting the hotel reservation, the system can require the user to choose the hotel.

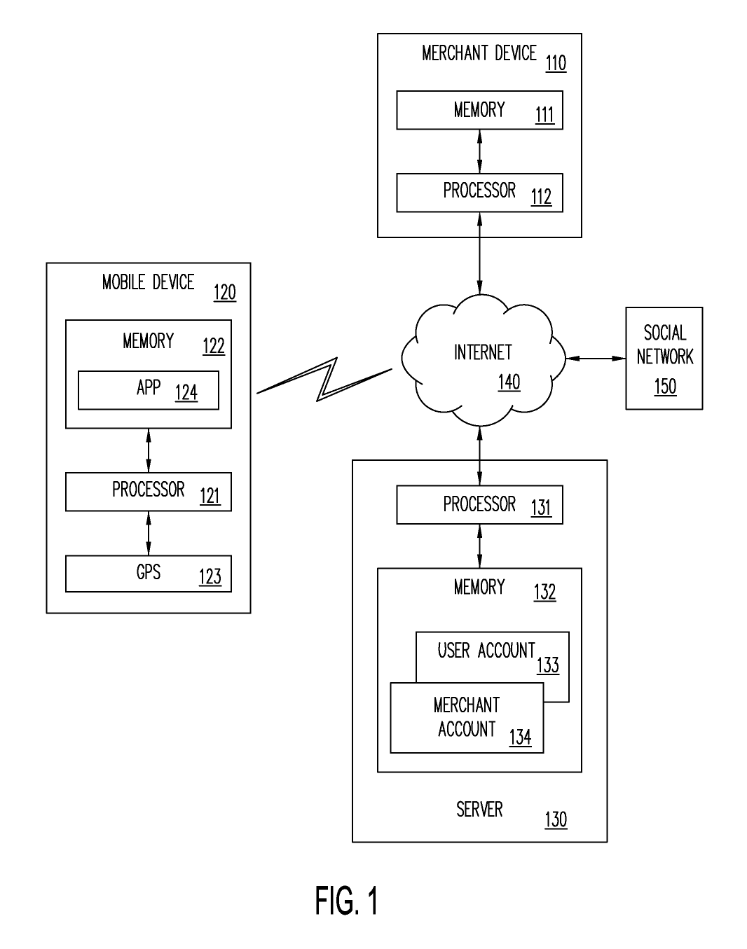

FIG. 1 is a block diagram of a system for trip planning and budgeting, according to an embodiment. The system can include a merchant device 110. The merchant device 110 can be a merchant checkout terminal, a computer, and/or a server, for example. The merchant device 110 can include a memory 111 and a processor 112. The merchant device 110 can be used for point of sales checkout. The merchant device 110 can be used for storing merchant information, such as in memory 111. The merchant information can include product names, product prices, product availability, product descriptions, and/or any incentives related to the products.

The system can include a mobile device 120. The mobile device 120 can be carried by the user. The mobile device 120 can be a cellular telephone, a smart telephone, a hand held computer, a laptop computer, a notebook computer, or a tablet computer, for example. The mobile device 120 can include a processor 121, a memory 122, and a global positioning system (GPS) 123.

The mobile device 120 can be used for routine telephone calls, text messaging, web browsing, and the like. The mobile device 120 can be used for practicing the method of trip planning and budgeting, as discussed herein. The mobile device 120 can be used for storing user preferences and/or merchant information, such as in memory 122.

An app 124 can be stored in the memory 122 and executed by the processor 121. The app 124 can be used for practicing the method of trip planning and budgeting, as discussed herein. The app 124 can be obtained, e.g., purchased, separately with respect to the mobile device 120. The app 124 can be installed on the mobile device 120, such as by the user.

The system can include a server 130. The server 130 can be a server of a payment provider, such as PayPal, Inc. The server 130 can be a single server or can be a plurality of servers. The server 130 can include one or more processors 131 and one or more memories 132. The memory 132 can be a memory of the server 130 or a memory that is associated with the server 130. The memory 132 can be a distributed memory. The memory 132 can store a user account 133 and a merchant account 134.

The server 130 can be used for practicing the method of trip planning and budgeting, as discussed herein. The server 130 can be used for storing user preferences and/or merchant information, such as in memory 132. The server 130 can be used for any other desired purpose, e.g., payment processing, online sales, etc.

One or more social networks 150 can store information regard the user, such as the user preferences. The social network can have a memory. The social network 150 can store information regarding merchants or products in the memory thereof. For example, the social network 150 can store merchant ratings and/or product ratings. Such merchant ratings and/or product ratings can be used by the system to make recommendations for purchases by the user.

The merchant device 110, the mobile device 120, the server 130, and the social network 150 can communicate with one another via a network, such as the Internet 140. The merchant device 110, the mobile device 120, the other mobile devices 130, and the server 130 can communicate with one another via one or more networks, such as local area networks (LANs), wide area networks (WANs), cellular telephone networks, and the like.

The merchant device 110, the mobile device 120, the other mobile devices 130, the social network 150, and the server 130 can communicate with one another, at least partially, via one or more near field communications (NFC) methods or other short range communications methods, such as infrared (IR), Bluetooth, WiFi, and WiMax.

FIG. 1 illustrates an exemplary embodiment of a network-based system for implementing one or more processes described herein. As shown, the network-based system may comprise or implement a plurality of servers and/or software components that operate to perform various methodologies in accordance with the described embodiments. Exemplary servers may include, for example, stand-alone and enterprise-class servers operating a server OS such as a MICROSOFT® OS, a UNIX® OS, a LINUX® OS, or another suitable server-based OS. It can be appreciated that the servers illustrated in FIG. 1 may be deployed in other ways and that the operations performed and/or the services provided by such servers may be combined or separated for a given implementation and may be performed by a greater number or fewer number of servers. One or more servers may be operated and/or maintained by the same or different entities.

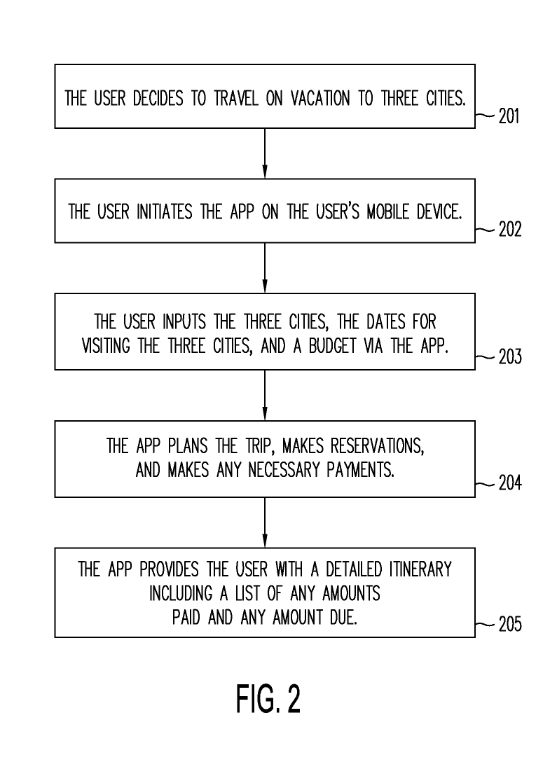

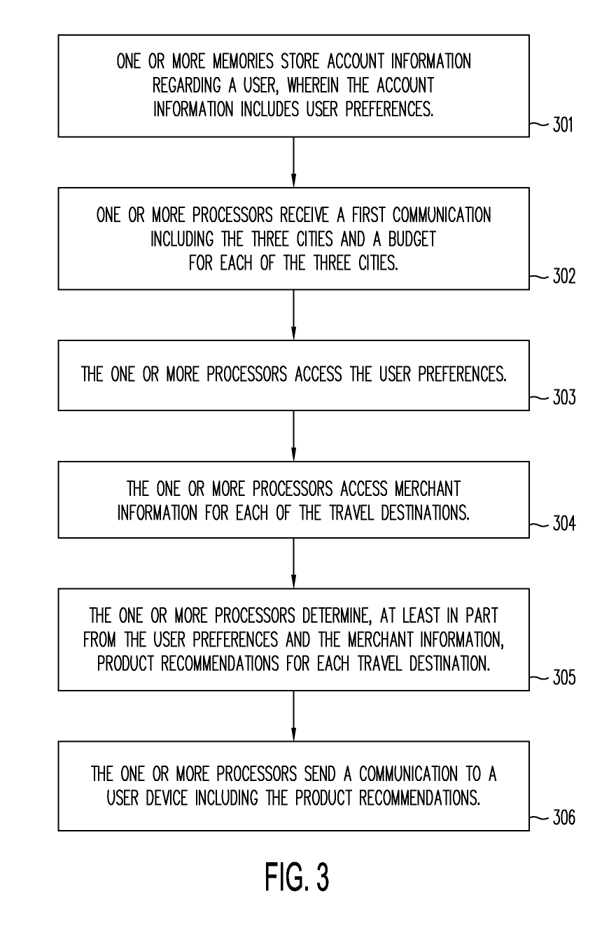

FIGS. 2 and 3 are flow charts that describe examples of operation of the travel planning and budgeting system, according to embodiments thereof. Note that one or more of the steps described herein may be combined, omitted, or performed in a different order, as desired or appropriate.

FIG. 2 is a flow chart showing an example of a method for travel planning and budgeting, according to an embodiment. According to this example, the user is visiting three cities for a vacation trip. FIG. 2 shows interactions of the user with the mobile device 120 and the app 124.

The user can decide to travel on vacation to three cities, as shown in step 201. Any number of cities or other travel destinations can be visited. The trip can be for any desired purpose.

The user can initiate the app 124 on the user's mobile device 120, as shown in step 202. The app can be on any device, such as the user's mobile device 120, a desktop computer, a laptop computer, a tablet computer, or any other device.

The user can input the three cities, the dates for visiting the three cities, and a budget via the app 124, as shown in step 203. The cities and dates can be input graphically, such as by using a graphic user interface (GUI) of the app. The cities and dates can be input textually or by any other method. The cities and dates can be transferred from a calendar, trip planner or other software of the user, of the user's employer, or of a travel planner, for example.

The budget can be a total budget for visiting all three cities. The budget can be a city-by-city budget with a separate amount for each city. Any combination of total budget and separate budgets can be used. For example, the user can input a total budget of $3,000 or can input a budget of $1000 per city. As a further example, the user can input a budget of $1,100 for each of the first two cities and a budget of $800 for the third city. The user can input any desired budget or combination of budgets.

The app 124 can plan the trip, makes reservations, and makes any necessary payments, as shown in step 204. The app 124 can autonomously plan the trip. The app 124 can cooperate with a trip planner, such as an online travel planner or agency, to plan the trip. The app 124 can work interactively with the user to plan the trip.

The app 124 can pay any required pre-payments or deposits, such as for airline reservations, car rentals, and/or hotels. An amount can be prepaid by the user, such as to a payment provider, for the trip. The amount can be the amount of the entire budget. The amount can be less than the full amount of the budget, such as an amount intended to cover any deposits or other upfront payments. The amount can be more than the full amount of the budget, such as an amount intended to cover the trip and some amount of contingencies, such as emergencies or unexpected purchases.

The app 124 can provide the user with a detailed itinerary including a list of any amounts paid and any amount due, as shown in step 205. The detailed itinerary can be displayed, such as upon the mobile device. The itinerary can be printed by the user or printed by a service and provided, e.g., faxed, emailed, or mailed, to the user.

FIG. 3 is a flow chart showing further detail of the method for travel planning and budgeting, according to an embodiment. Again, the user is visiting three cities for a vacation trip. FIG. 3 show functions that can be performed by the mobile device 120, the server 130, and/or any other device or system.

One or more memories can store account information regarding a user, wherein the account information includes user preferences, as shown in step 301. The preferences can include preferences regarding travel. For example, the preferences can indicate preferred airlines, car rental companies, hotels, restaurants, products, and the like.

The preferences can include negative preferences. That is, the preferences can indicate which airlines, car rental companies, hotels, restaurants, products, and the like that the user would prefer to avoid. Such negative preferences can be avoided by the system unless there is no alternative.

Product choices, such as which airline, car rental company, hotel, and restaurants, a restaurant to use, can be weighted (assigned weighting factor where higher weighting factors indicate that the product is more highly desired). In this manner, several choices for each product can be considered and the one with the highest weighting factor can be recommended. The product choices can be weighted by the user during as setup process, for example. As a further example, the product choices can be weighted by the user substantially in real time, such as during use or review of the product choices.

One or more processors can receive a first communication including the three cities and a budget for each of the three cities, as shown in step 302. The first communication can be sent from the user device 120 to the server 130, for example. In this instance, at least one of the memories can be the memory 132 of the server 130 and at least one of the processors can be the processor 131 of the server 130.

The first communication can be sent internally with respect to the user device 120.

For example, the first communication can be sent from an input device, e.g., a keyboard or a touchscreen, of the mobile device 120 to the processor 121 of the mobile device 120. In this instance, at least one of the memories can be the memory 122 of the mobile device 120 and at least one of the processors can be the processor 121 of the mobile device 120. Thus, the mobile device 120 can substantially autonomously (at least without the sever 130) practice the method.

The one or more processors can access the user preferences, as shown in step 303. The user preferences can be stored in a memory of the system. For example, the user preferences can be stored in the memory 122 of the mobile device 120, the memory 132 of the server 130, or any other memory. The user preferences can be stored in a memory of a social network website. The user preferences can be stored in a memory 111 of a merchant device 110.

The one or more processors can access merchant information for each of the travel destinations, as shown in step 304. For example, the merchant information can be stored in a memory 111 of a merchant device 110. The merchant information can be stored in the memory 122 of the mobile device 120, the memory 132 of the server 130, or any other memory. The merchant information can be stored in a memory of a social network website. The merchant information can include product pricing information, product availability information, specials, discounts, and incentives.

The one or more processors can determine, at least in part from the user preferences and the merchant information, product recommendations for each travel destination, as shown in step 305. The user can have the option to okay or authorized purchases. The system can make purchase autonomously, e.g., without each purchase being authorized. For example, the user can pre-authorized certain purchase, types of purchases, or categories of purchases, such as during a setup process.

The one or more processors can send a communication to a user device including the product recommendations, as shown in step 306. The communication can include pricing for the product recommendations. The communication can note which of the recommended product have been purchased, reserved, had a deposit placed thereon, or required authorization before any further action is taken.

In implementation of the various embodiments, embodiments of the invention may comprise a personal computing device, such as a personal computer, laptop, PDA, cellular phone or other personal computing or communication devices. The payment provider system may comprise a network computing device, such as a server or a plurality of servers, computers, or processors, combined to define a computer system or network to provide the payment services provided by a payment provider system.

In this regard, a computer system may include a bus or other communication mechanism for communicating information, which interconnects subsystems and components, such as a processing component (e.g., processor, micro-controller, digital signal processor (DSP), etc.), a system memory component (e.g., RAM), a static storage component (e.g., ROM), a disk drive component (e.g., magnetic or optical), a network interface component (e.g., modem or Ethernet card), a display component (e.g., CRT or LCD), an input component (e.g., keyboard or keypad), and/or cursor control component (e.g., mouse or trackball). In one embodiment, a disk drive component may comprise a database having one or more disk drive components.

The computer system may perform specific operations by processor and executing one or more sequences of one or more instructions contained in a system memory component. Such instructions may be read into the system memory component from another computer readable medium, such as static storage component or disk drive component. In other embodiments, hard-wired circuitry may be used in place of or in combination with software instructions to implement the invention.

Payment processing can be through known methods, such as transaction details being communicated to the payment provider through the app, the payment provider processing the details, which may include user account and identifier information and authentication, merchant information, and transaction details. The user account may be accessed to determine if any restrictions or limitations may prevent the transaction from being approved. If approved, the payment provider may send a notification to the merchant and/or the user.

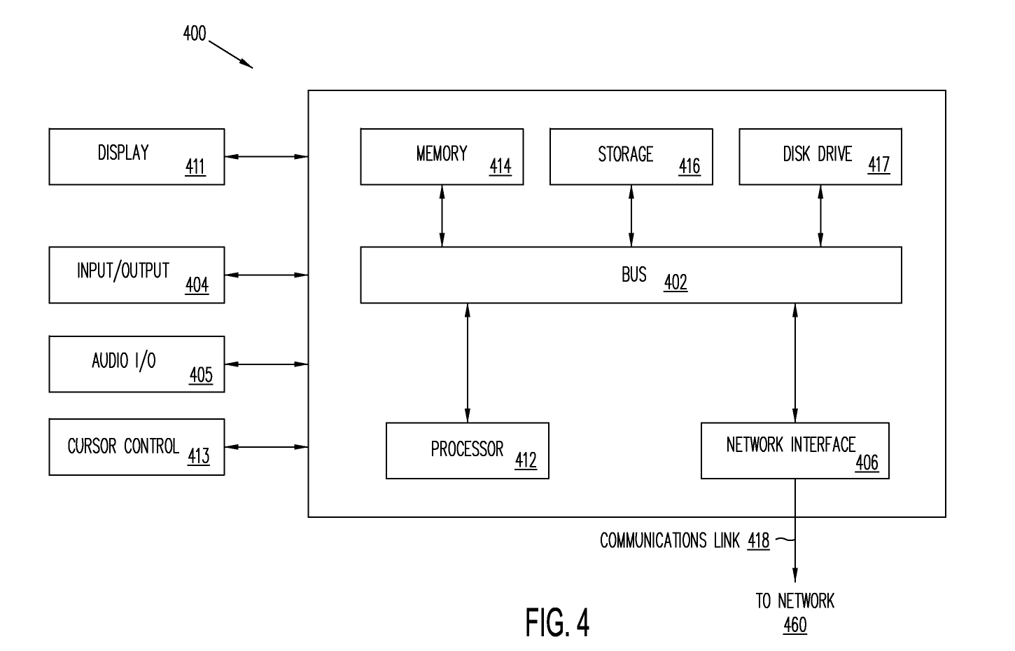

FIG. 4 is a block diagram of a computer system 400 suitable for implementing one or more embodiments of the present disclosure. In various implementations, the PIN pad and/or merchant terminal may comprise a computing device (e.g., a personal computer, laptop, smart phone, tablet, PDA, Bluetooth device, etc.) capable of communicating with the network. The merchant and/or payment provider may utilize a network computing device (e.g., a network server) capable of communicating with the network. It should be appreciated that each of the devices utilized by users, merchants, and payment providers may be implemented as computer system 400 in a manner as follows.

Computer system 400 includes a bus 402 or other communication mechanism for communicating information data, signals, and information between various components of computer system 400. Components include an input/output (I/O) component 404 that processes a user action, such as selecting keys from a keypad/keyboard, selecting one or more buttons or links, etc., and sends a corresponding signal to bus 402. I/O component 404 may also include an output component, such as a display 411 and a cursor control 413 (such as a keyboard, keypad, mouse, etc.). An optional audio input/output component 405 may also be included to allow a user to use voice for inputting information by converting audio signals. Audio I/O component 405 may allow the user to hear audio. A transceiver or network interface 406 transmits and receives signals between computer system 400 and other devices, such as a user device, a merchant server, or a payment provider server via network 460. In one embodiment, the transmission is wireless, although other transmission mediums and methods may also be suitable. A processor 412, which can be a micro-controller, digital signal processor (DSP), or other processing component, processes these various signals, such as for display on computer system 400 or transmission to other devices via a communication link 418. Processor 412 may also control transmission of information, such as cookies or IP addresses, to other devices.

Components of computer system 400 also include a system memory component 414 (e.g., RAM), a static storage component 416 (e.g., ROM), and/or a disk drive 417. Computer system 400 performs specific operations by processor 412 and other components by executing one or more sequences of instructions contained in system memory component 414. Logic may be encoded in a computer readable medium, which may refer to any medium that participates in providing instructions to processor 412 for execution. Such a medium may take many forms, including but not limited to, non-volatile media, volatile media, and transmission media. In various implementations, non-volatile media includes optical or magnetic disks, volatile media includes dynamic memory, such as system memory component 414, and transmission media includes coaxial cables, copper wire, and fiber optics, including wires that comprise bus 402. In one embodiment, the logic is encoded in non-transitory computer readable medium. In one example, transmission media may take the form of acoustic or light waves, such as those generated during radio wave, optical, and infrared data communications.

Some common forms of computer readable and executable media include, for example, floppy disk, flexible disk, hard disk, magnetic tape, any other magnetic medium, CD-ROM, any other optical medium, punch cards, paper tape, any other physical medium with patterns of holes, RAM, ROM, E2PROM, FLASH-EPROM, any other memory chip or cartridge, carrier wave, or any other medium from which a computer is adapted to read.

In various embodiments, execution of instruction sequences for practicing the invention may be performed by a computer system. In various other embodiments, a plurality of computer systems coupled by a communication link (e.g., LAN, WLAN, PTSN, or various other wired or wireless networks) may perform instruction sequences to practice the invention in coordination with one another.

Modules described herein can be embodied in one or more computer readable media or be in communication with one or more processors to execute or process the steps described herein.

A computer system may transmit and receive messages, data, information and instructions, including one or more programs (i.e., application code) through a communication link and a communication interface. Received program code may be executed by a processor as received and/or stored in a disk drive component or some other non-volatile storage component for execution.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa—for example, a virtual Secure Element (vSE) implementation or a logical hardware implementation.

Software, in accordance with the present disclosure, such as program code and/or data, may be stored on one or more computer readable and executable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The system can make recommendations for spending and/or can spend the user's money anywhere along a travel route. Deviations or side trips can be suggested or added and the system can make recommendations for spending and/or can spend the user's money anywhere along such deviations or side trips.

The user can prepay a total amount or budget for the trip. The user can prepay any portions of the total amount or budget for the trip. Each travel destination can have a separate budget. The user can prepay all or any desired combination of such separate budgets. The user can have the system make recommendations and/or spend the user's money for the entire trip or any portion thereof. The user can have the system make recommendations and/or spend the user's money for only those travel destination that are specified by the user.

Each travel destination can a country, city, town, area, neighborhood, hotel, business, or anything else that can be designate by or can designate a location. For example, the United States, New York State, New York City, Manhattan, the Upper East Side of Manhattan, and the Regency Hotel can all be travel destinations.

As used herein, the term “card” can refer to any card or other device that can be used to make a purchase in place of cash. For example, the card can be a bank card, credit card, debit card, gift card, or other device. The card can be a token, such as a hardware token or a software token. The card can be stored in and/or displayed upon a user device, such as a cellular telephone.

As used herein, the term “store” can include any business or place of business. The store can be a brick and mortar store or an online store. The store can be any person or entity that sells a product.

As used herein, the term “product” can include any item or service. Thus, the term “product” can refer to physical products, digital goods, services, or anything for which a user can make a payment, including charitable donations. A product can be anything that can be sold. Examples of products include cellular telephones, concerts, hotel rooms, meals, automotive repair, haircuts, digital music, and books. The product can be a single item or a plurality of items. For example, the product can be a tube of toothpaste, a box of laundry detergent, three shirts, and a donut.

As used herein, the term “merchant” can include any seller of products. The term merchant can include a store. The products can be sold from a store or in any other manner.

As used herein, the term “mobile device” can include any portable electronic device that can facilitate data communications, such as via a cellular network and/or the Internet. Examples of mobile devices include cellular telephones, smart phones, tablet computers, and laptop computers.

As used herein, the term “network” can include one or more local area networks (LANs) such as business networks, one or more wide area networks (WANs) such as the Internet, one or more cellular telephone networks, or any other type or combination of electronic or optical networks.

The foregoing disclosure is not intended to limit the present invention to the precise forms or particular fields of use disclosed. It is contemplated that various alternate embodiments and/or modifications to the present invention, whether explicitly described or implied herein, are possible in light of the disclosure. Having thus described various example embodiments of the disclosure, persons of ordinary skill in the art will recognize that changes may be made in form and detail without departing from the scope of the invention. Thus, the invention is limited only by the claims.

What is claimed is:

1. A system comprising:
one or more memories storing account information regarding a user, the account information including user preferences;
one or more processors operable to:
receive a first communication including at least one travel destination and a budget for each travel destination;
access the user preferences;
access merchant information for each of the travel destinations;
determine, at least in part from the user preferences and the merchant information, product recommendations for each travel destination; and
send a communication to a user device including the product recommendations.

2. The system of claim 1, wherein:
at least one of the memories and at least one of the processors are associated with a payment server; and
the payment server is configured to receive pre-payment for purchases made by the user at the travel destinations and each travel destination has a specified portion of the pre-payment associated therewith to define a budget for each travel destination.

3. The system of claim 1, wherein the one or more processors are further operable to receive a prepaid amount from the user for each destination.

4. The system of claim 1, wherein the one or more processors are further operable to spend a prepaid amount for the user at each destination.

5. The system of claim 1, wherein the first communication includes a plurality of travel destinations.

6. The system of claim 1, wherein:
the first communication includes a plurality of travel destinations; and
when spending of the user is less than the budget for one destination by an amount, then the budget for the next destination is increased by the amount.

7. The system of claim 1, wherein:
the first communication includes a plurality of travel destinations; and
when spending of the user is less than the budget for one destination by an amount, then the budget for the remaining destinations is increased by the amount and the amount is split among the remaining destinations.

8. The system of claim 1, wherein the product recommendations are determined, at least in part, from a social network of the user.

9. The system of claim 1, wherein the one or more processors are further operable to receive a third communication from a mobile device of the user including a GPS location of the user.

10. The system of claim 1, wherein the one or more processors are further operable to:
receive a third communication including an indication that the user has left one of the travel destinations; and
perform a non-payment action for the user in response to the third communication.

11. The system of claim 1, wherein the one or more processors are further operable to:
receive a third communication including an indication that the user has left one of the travel destinations; and
upload photographs for the user in response to the third communication.

12. The system of claim 1, wherein the one or more processors are further operable to confirm a hotel reservation for the user when the user is within a predetermined distance from the hotel.

13. The system of claim 1, wherein the one or more processors are further operable to place an order for the user when the user is at a predetermined location.

14. The system of claim 1, wherein the one or more processors are further operable to ship an item for the user when the user is at a predetermined location.

15. The system of claim 1, wherein the one or more processors are further operable to ship an item to a next travel destination of the user when the user is at a predetermined location.

16. The system of claim 1, wherein the one or more processors are further operable to:
receive a third communication including an indication that the user has deviated by more than a predetermined amount from an expected path; and
perform one or more predetermined operations in response to the third communication.

17. The system of claim 1, wherein the one or more processors are further operable to:
receive a third communication including an indication that the user has deviated by more than a predetermined amount from an expected path; and
lock an account in response to the third communication.

18. The system of claim 1, wherein the one or more processors are further operable to suggest purchases to the user based, at least in part, upon incentives at the travel destination when the user is expected to be at the travel destinations.

19. A method comprising:
storing, in one or more memories, account information regarding a user, the account information including user preferences;
receiving, electronically via one or more processors, a first communication including at least one travel destination and a budget for each travel destination;
accessing, electronically via the one or more processors, the user preferences;
accessing, electronically via the one or more processors, merchant information for each of the travel destinations;
determining, electronically via the one or more processors and at least in part from the user preferences and the merchant information, product recommendations for each travel destination; and
sending, electronically via the one or more processors, a communication to a user device including the product recommendations.

20. A computer program product comprising a non-transitory computer readable medium having computer readable and executable code for instructing one or more processors to perform a method, the method comprising:
storing account information regarding a user, the account information including user preferences;
receiving a first communication including at least one travel destination and a budget for each travel destination;
accessing the user preferences;
accessing merchant information for each of the travel destinations;
determining, at least in part from the user preferences and the merchant information, product recommendations for each travel destination; and
sending a communication to a user device including the product recommendations.
